(19) United States
(12) Patent Application Publication
(10) Pub. No.: US 2015/0153314 A1
(43) Pub. Date: Jun. 4, 2015

(54) Fast Field Mud Gas Analyzer

(71) Applicants: Geoservices Equipements, Paris (FR); Schlumberger Technology Corporation, Sugar Land, TX (US)

(72) Inventors: Reda Karoum, Thiais (FR); Raphael Houdebourg, Issy les Moulineaux (FR); Bertrand Bourlon, La Colle Sur Loup (FR); Jerome Breviere, Taverny (FR); Patrick Banik, Paris Nord II (FR); Kamran Danaie, Vincennes (FR)

(73) Assignees: Geoservices Equipements, Paris (FR); Schlumberger Technology Corporation, Sugar Land, TX (US)

(21) Appl. No.: 14/094,726

(22) Filed: Dec. 2, 2013

(51) Int. Cl. G01N 30/86; G01N 30/78; G01N 30/68; G01N 30/10; G01N 30/66

(52) U.S. Cl. CPC G01N 30/8658; G01N 30/10; G01N 30/66; G01N 30/68; G01N 30/78; G01N 2030/025

(57) ABSTRACT

A fast field mud gas analyzer is presented. The fast field mud gas analyzer has a splitter system; a plurality of analytical lines composed of a micro chromatographic column and one or more detector; one or more heating element; and a computer system. The splitter system selectively applies a portion of an effluent sample flow through one or more outlets. The analytical lines are in fluid communication with the splitter system and receive at least a portion of the effluent sample flow. The micro chromatographic column separates portions of the effluent sample flow. The detector analyzes the separated portions and generates information indicative of analysis of the separated portions. The heating element heats the portion of the effluent sample flow within the analytical line. The computer system controls the splitter system and the one or more heating element and receives the information from the detectors.

### BACKGROUND

Gas phase chromatography is a technique which may be used for the separation and quantification of mud gas components. Mud gas analysis using gas phase chromatography may allow monitoring of the drilling process for safety and performing a pre-evaluation of the type of fluids encountered in drilled formations. To extract gases from the drilling fluid, a degasser such as the Geoservices Extractor, U.S. Pat. No. 7,032,444 may be used. After extraction, the mud gases may be transported and analyzed in order to describe a mud gas event while drilling. It may be desirable to perform a qualitative and/or quantitative continuous compositional or isotopic analysis on fluids involved in mud gas analysis to be able to characterize the hydrocarbons present in the drilled formations versus depth. The more measurements performed, the better the level of resolution of gas events described by the mud logging services.

Rapid and continuous mud gas compositional and isotopic characterization may enable increased quality of data used to elaborate gas logs. Quality of the gas log may be related to the type of degasser equipment used on site and the frequency of measurements of the mud gas during drilling operations. Currently, typical gas chromatographic equipment may allow a C₁ to C₅ analysis in less than one minute. Nevertheless, this typical analysis cycle time may be inadequate for the industry.

Some of the miniaturized analysis systems currently in use lack desired accuracy and reproducibility of analysis results for the mud log. Current miniaturized analysis systems lack integration in many substantial components, such as the injection system, the separation column, and the detectors. Miniaturization and integration of components within the mud gas analyzer may allow for elimination of dead volumes within the gas stream, lower energy requirements, and small size for use on drilling sites. However, some miniaturized systems use ball valves, such as the application DE 19,726,000 which allow for dead volumes resulting in an adverse effect on the mud log. Other miniaturized systems employ diaphragm valves resulting in dead volumes within the gas chromatograph injection system and columns switching devices.

### SUMMARY

In one version, the present disclosure is directed to a fast field mud gas analyzer for analyzing an effluent sample flow separated from mud gas during a drilling operation. The fast field mud gas analyzer is provided with a splitter system, a plurality of analytical lines in fluid communication with the splitter system, a heating element associated with certain of the plurality of analytical lines, and a computer system. The splitter system selectively applies a portion of an effluent sample flow through outlets. The plurality of analytical lines receives at least a portion of the effluent sample flow from the splitter system. Each of the plurality of analytical lines has a micro chromatographic column which separates portions of the effluent sample flow and a detector which analyzes the separated portions of the effluent sample flow and generates information indicative of analysis of the portions of the effluent sample flow. The heating element heat the portion of the effluent sample flow in the analytical line with which the heating element is associated. The computer system controls the splitter system and the heating element and receives information from the plurality of analytical lines. In some embodiments, the fast field mud gas analyzer may also include a cooling system associated with certain of the plurality of analytical lines which cools a portion of the effluent sample flow directed to the analytical line with which the cooling system is associated.

In another embodiment, the fast field mud gas analyzer is provided with a splitter system, a plurality of analytical lines in fluid communication with the splitter system, a heating element associated with certain of the plurality of analytical lines, and a computer system. The splitter system selectively applies a portion of an effluent sample flow through a plurality of outlets. The plurality of analytical lines receives at least a portion of the effluent sample flow from the splitter system. Each of the plurality of analytical lines has a plurality of micro chromatographic column which separate portions of the effluent sample flow and a detector which analyzes the separated portions of the effluent sample flow and generates information indicative of analysis of the portions of the effluent sample flow. The heating elements heat the portion of the effluent sample flow in the analytical line with which the heating element is associated. The computer system controls the splitter system and the heating element and receives information from the plurality of analytical lines. In some embodiments, the fast field mud gas analyzer may also include a cooling system associated with certain of the plurality of analytical lines which cools a portion of the effluent sample flow directed to the analytical line with which the cooling system is associated.

In another version, the present disclosure is directed to a method for analyzing mud gas. The method is performed by introducing a first portion of an effluent sample to a first analytical line having a micro chromatograph column at discrete instant of time T₁ and introducing a second portion of the effluent sample to a second analytical line having a micro chromatograph column at a discrete instant of time T₂. The method is further performed by analyzing the first portion of the effluent sample with a detector in fluid communication with the first analytical line at time T₃ and analyzing the second portion of the effluent sample with a detector in fluid communication with the second analytical line at time T₄. The times T₃ and T₄ are subsequent to the times T₁ and T₂.

### BRIEF DESCRIPTION OF DRAWINGS

Certain embodiments of the present inventive concepts will hereafter be described with reference to the accompanying drawings, wherein like reference numerals denote like elements, and:

FIG. 1 is a schematic view of one embodiment of a fast field mud gas analyzer in accordance with the present disclosure.

FIG. 2 is a schematic view of an analytical line of the fast field mud gas analyzer of FIG. 1.

FIG. 3 is a schematic view of another embodiment of a fast field mud gas analyzer in accordance with the present disclosure.

FIG. 4 is a schematic view of a computer system in accordance with the present disclosure.

FIG. 5 is a flow diagram of the fast field mud gas analyzer of FIG. 1 in operation

### DETAILED DESCRIPTION

Specific embodiments of the present disclosure will now be described in detail with reference to the accompanying drawings. Further, in the following detailed description of embodiments of the present disclosure, numerous specific details are set forth in order to provide a more thorough understanding of the disclosure. However, it will be apparent to one of ordinary skill in the art that the embodiments disclosed herein may be practiced without these specific details. In other instances, well-known features have not been described in detail to avoid unnecessarily complicating the description.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

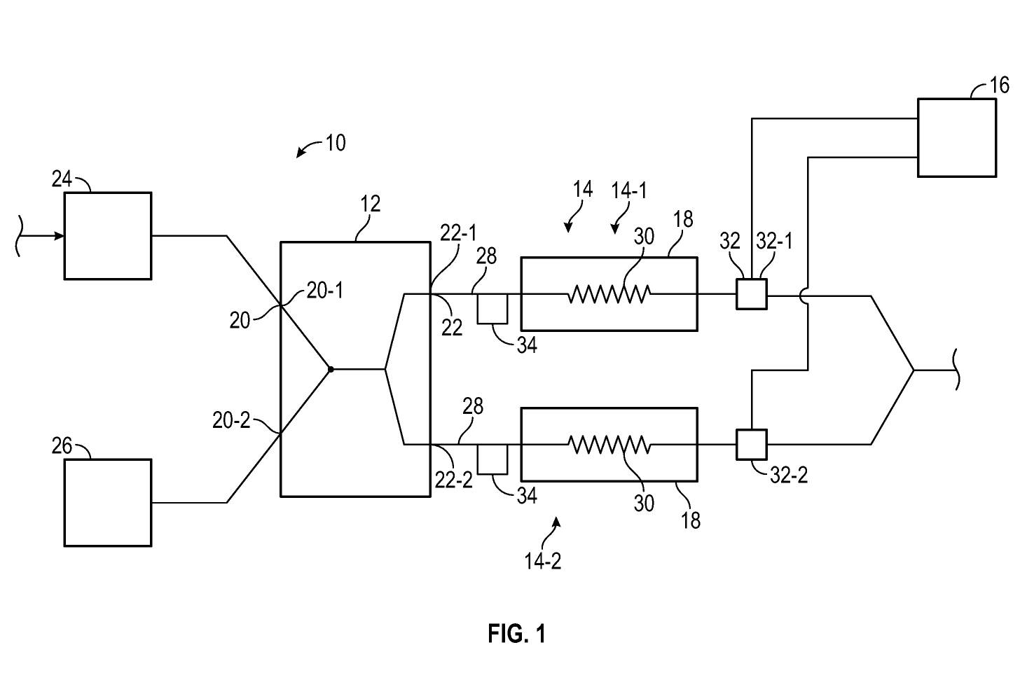

Referring now to the figures, shown in FIG. 1 is a schematic view of a fast field mud gas analyzer 10 for rapidly and continuously analyzing gasses in a drilling fluid or drilling mud at a well site. In one embodiment, the fast field mud gas analyzer 10 is provided with a splitter system 12, a plurality of analytical lines 14, and a computer system 16. The plurality of analytical lines 14 may be used in a parallel fashion to implement the rapid and continuous analysis of gasses in the drilling fluid or the drilling mud. The computer system 16, which will be described below, may be configured to control the splitter system 12 and receive signals indicative of gas/liquid analysis from the plurality of analytical lines 14. The fast field mud gas analyzer 10 may also include one or more heating element 18 associated with certain of the plurality of analytical lines 14 and configured to heat gasses passing through the analytical line 14 with which the one or more heating element 18 is associated. Where provided with the one or more heating element 18, the computer system 16 may also control activation of the one or more heating element 18. As shown in FIG. 1, the fast field mud gas analyzer 10 may be implemented as an independent micro chromatograph having two analytical lines 14-1 and 14-2 that each function as an independent micro gas chromatograph.

As will be explained in more detail below, the plurality of analytical lines 14 may function as a plurality of gas chromatographs. The fast field mud gas analyzer 10 may be based on miniaturization of parts, especially for the plurality of analytical lines 14. In some embodiments, components used in conjunction with the fast field mud gas analyzer 10 may be implemented as standard size components, such as power sources, furnaces, and certain detectors.

The miniaturization, focused on the plurality of analytical lines 14, may allow a high frequency analysis. The high frequency analysis may be performed at a predetermined frequency. In essence, the more analytical lines placed in an instrument the faster the analysis. By combining the plurality of analytical lines 14, acting as a plurality of individual miniaturized gas chromatographs independently producing a plurality of gas chromatographic analyses, reconstruction by time of the plurality of gas chromatographic analyses may produce a measurement at a predetermined frequency. The predetermined frequency of measurement may allow the fast field mud gas analyzer 10 to perform a final chemical analysis of a mud gas event in less than twenty seconds.

To achieve this result, the fast field mud gas analyzer 10 has an architecture based on coordination of the plurality of analytical lines 14, allowing generation of a log where gas data extracted from the mud may be plotted as a function of time and/or depth with high precision. For high frequency analysis, a number of the plurality of analytical lines 14 may be increased. Increasing the number of the plurality of analytical lines 14 may enable the reconstruction by sequence of the data produced, providing high analytical resolution in time and improving the quality of a mud gas log.

In one embodiment, the fast field mud gas analyzer 10 uses a combination of micro-electro-mechanical systems to monitor and quantify the mud gasses at a very short cycle time, which is less than a time that it takes for a single analyzer to analyze the mud gases. For example, the rapid and accurate gas analysis can be performed at twenty second intervals or even less depending upon the number of analytical lines 14 in the fast field mud gas analyzer 10. The fast field mud gas analyzer 10 can be considered to be a gas composition detector that can be plugged into any gas line providing a C₁ to C₁₀ gas composition versus time, with a final measurement given at twenty second intervals or even less.

In some embodiments, the fast field mud gas analyzer 10 may be able to analyze in parallel gas and/or liquid independently using any suitable sample preparation, such as cooling systems to condensate polar or heavy molecules prior to an analysis. In such embodiments, the fast field mud gas analyzer may include one or more cooling systems, as will be described in more detail below.

Rapid and continuous mud gas compositional and isotopic characterization as described herein will enable an increase in the quality and the data used to elaborate gas logs. Due to the short data cycle time and the number of the plurality of analytical lines 14 present, the precision of the gas log is less dependent of a rate of penetration of the drilling tools. Thus, a gas determination may be linked to a type of degasser equipment used on site and a frequency of measurement of the mud gas while drilling.

By way of example, the fast field mud gas analyzer 10 may be designed to provide a gas composition measurement at a very short time (e.g., twenty seconds or less) with the possibility to detect and quantify compounds other than hydrocarbons such as carbon dioxide (CO₂), hydrogen sulfide (H₂S), ammonia (NH₃) and any other molecules being the product of a catalytic reaction of the mud gas, depending on the type of detector (as described below). This is achieved by using the plurality of analytical lines 14 in parallel. It should be noted that the more analytical lines 14 used, the faster the response time can be achieved. For example, if the fast field mud gas analyzer 10 includes six different analytical lines 14, with a complete chromatographic cycle time of one minute for an individual analytical line 14, the splitter system 12 injects a sample of the effluent sample flow each ten seconds into a different analytical line 14 of the plurality of analytical lines 14. In this embodiment, the fast field mud gas analyzer 10 may provide a complete gas analysis at ten second intervals after the first one minute analysis cycle time by providing a new injection into the five other analytical lines 14 at ten second intervals. Thus, by designing the fast field mud gas analyzer 10 with a predetermined architecture where the plurality of analytical lines 14 are used in succession, the readings of each analytical line 14 are synchronized in order to provide a global analysis at a high frequency. Then, in this embodiment, the fast field mud gas analyzer can provide a compositional analysis at ten second intervals instead of a compositional analysis at one minute intervals with a single analytical line.

In some embodiments, the fast field mud gas analyzer 10 may integrate a catalytic reactor prior to the splitter system 12, to transform certain molecules into their oxidized forms being less dangerous for the fast field mud gas analyzer 10 and more distinguishable. For example, the analyze NH₃, a catalytic reactor may be placed in the fast field mud gas analyzer 10 in the effluent sample flow path prior to an certain of the plurality of analytical lines 14 in order to transform the NH₃ into NO₂ and/or NO in a controlled manner. In this way, the direct measurements of NO₂/NO may be associated at the concentration of ammonia in the mud gas. The fast field mud gas analyzer 10 may contain one or more of a plurality of catalytic reactors, such as the one described in WO 2012/052962, which is hereby incorporated by reference.

As shown in FIG. 1, the splitter system 12 may receive samples of mud gas and carrier gas, mix the mud and carrier gasses and selectively supply the mud and carrier gas mixture, an effluent sample flow, to particular ones of the plurality of analytical lines 14 at discrete instants of time which may be in a range from about one second to about thirty seconds apart, for example. The splitter system may be provided with one or more inlet 20 and a plurality of outlets 22. Between the one or more inlet 20 and the plurality of outlets 22, in one embodiment, the splitter system may be provided with a plurality of valves to mix the mud and carrier gasses and selectively separate samples of the resulting effluent sample flow. The plurality of valves may cause the plurality of outlets 22 to receive the selectively separated samples of the effluent sample flow and pass the separated samples to the particular ones of the plurality of analytical lines 14.

The one or more inlet 20 may include a sample inlet 20-1 and a carrier gas inlet 20-2. The sample inlet 20-1 may be connected to an effluent sample 24 to supply the splitter system 12 with samples or a sample stream of effluent, such as mud gas. The carrier gas inlet 20-2 may be connected to a carrier gas supply 26 to supply the splitter system 12 with a carrier gas stream for mixing with the mud gas. The carrier gas within the carrier gas supply 26 may be used as a medium to assist in carrying components, such as solutes, within the mud gas through the plurality of analytical lines 14 within the fast field mud gas analyzer 10. The carrier gas may be air, Helium, Hydrogen, or any other suitable carrier gas for use in gas/liquid chromatography. The effluent sample 24 may comprise mud gasses, gasses and liquids from drilled formations, any compounds being the result of a catalytic reaction, and the gas or liquid produced during drilling operations. For example, the effluent sample 24 may be mud gas separated from a drilling mud within a wellbore indicative of the gas and liquid contents contained within a formation through which the wellbore passes.

The plurality of outlets 22 may be in fluid communication with certain of the plurality of analytical lines 14 so that the splitter system 12 may selectively pass the effluent sample flow to the plurality of analytical lines 14-1 and 14-2. The fast field mud gas analyzer 10 may be provided with fluid connections between the plurality of outlets 20 of the splitter system 12 and the plurality of analytical lines 14-1 and 14-2 where the splitter system 12 and the plurality of analytical lines are separated from one another, as shown in FIG. 1.

In one embodiment, the splitter system 12 is provided with two outlets 22-1 and 22-2. The two outlets 22-1 and 22-2 connect to the two analytical lines 14-1 and 14-2, where the first outlet 22-1 connects to the first analytical line 14-1 and the second outlet 22-2 connects to the second analytical line 14-1, to selectively provide the analytical lines 14-1 and 14-2 with the effluent sample flow. In this embodiment, the splitter system 12 may be implemented as a micro-electro-mechanical system (MEMS) of valves embodied by a plurality of substrates and membranes in fluid communication with the plurality of analytical lines 14-1 and 14-2 via one or more capillary tubes 28 in fluid communication with the plurality of outlets 22-1 and 22-2. Certain of the MEMS valves may mix the mud and carrier gasses within the splitter system 12 and certain of the MEMS valves may selectively provide the effluent sample flow, resulting from the mixture of mud and carrier gasses, to certain of the plurality of analytical lines 14-1 and 14-2. The capillary tubes 28 connecting the plurality of outlets 22-1 and 22-2 and the plurality of analytical lines 14-1 and 14-2 may be in the form of 100 μm fused silica tubing of varying lengths depending on the distance between the splitter system 12 and the plurality of analytical lines 14-1 and 14-2. In another embodiment, the splitter system 12 may be a set of MEMS valves embodied by a plurality of substrates and membranes integral to and in fluid communication with the plurality of analytical lines 14-1 and 14-2. In yet another embodiment, the splitter system 12 may be implemented as a six way valve, a series of valves linked in parallel, or any other suitable structure capable of selectively applying a effluent sample flow of the mud and carrier gasses from the effluent sample 24 and the carrier gas supply 26 to the plurality of analytical lines 14-1 and 14-2.

The splitter system 12 may be connected to the computer system 16 such that the computer system 16 may cause the splitter system 12 to selectively activate valves to cause the splitter system 12 to selectively direct samples of the effluent sample flow through the plurality of outlets 22-1 and 22-2 to the particular ones of the plurality of analytical lines 14-1 and 14-2. For example, the computer system 16 may cause the splitter system 12 to actuate the plurality of valves to direct a first portion of the effluent sample flow through the first outlet 22-1 and then actuate the plurality of valves to direct a second portion of the effluent sample flow through the second outlet 22-2. The plurality of analytical lines 14-1 and 14-2 may then, at progressive instants of time, receive the first portion of the effluent sample flow into the first analytical line 14-1 from the first outlet 22-1 and the second portion of the effluent flow sample into the second analytical line 14-2 from the second outlet 22-2. The first and second analytical lines 14-1 and 14-2 may then analyze the first and second portions of the effluent flow sample in overlapping periods of time, i.e., in parallel.

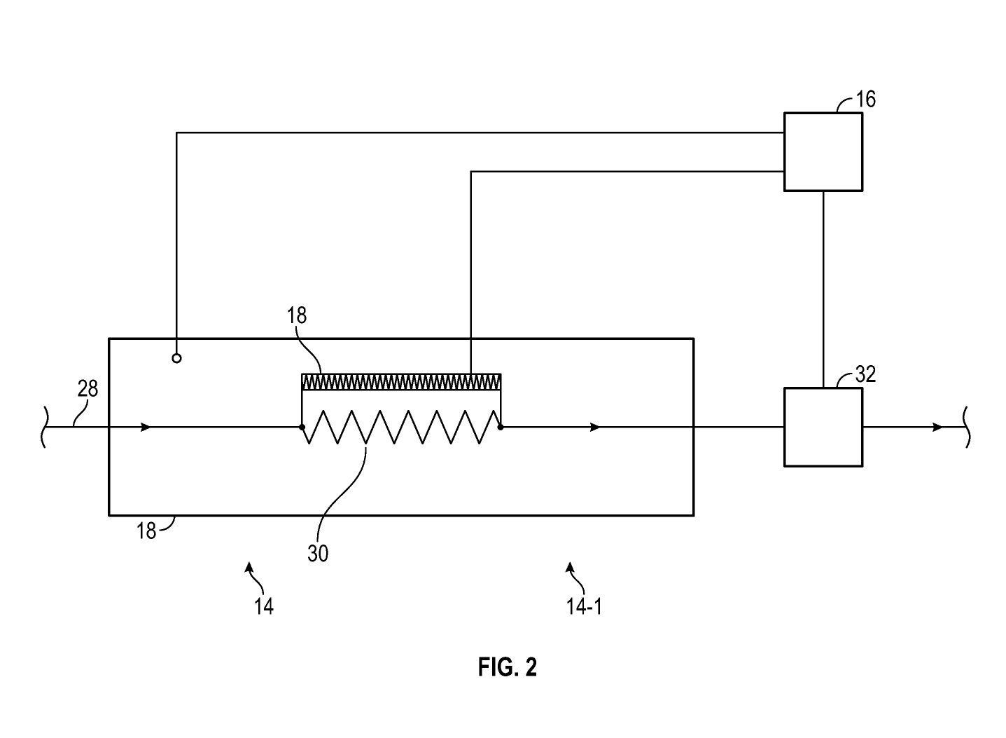

Referring now to FIGS. 1 and 2, although the fast field mud gas analyzer 10 may have the plurality of analytical lines 14, for simplicity, the plurality of analytical lines 14 will be described in reference to a single analytical line 14. By way of example, the fast field mud gas analyzer 10 may be implemented with the plurality of analytical lines 14 as single integrated chromatographic systems having a single micro chromatographic column similar to the one described in U.S. Pub. No. 2013/0174642. The analytical line 14 may include a micro chromatographic column 30 configured to separate portions of the effluent sample flow and one or more detector 32 configured to analyze the separated portions of the effluent sample flow and generate information indicative of analysis of the portions of the effluent sample flow. The one or more detectors 32 may be used for determining type, quantity, and/or other characteristics of compounds within the effluent sample that have separated by passing through the micro chromatographic column 30 and may be placed at a terminus for the micro chromatographic column 30. Although the fast field mud gas analyzer 10 is shown in FIG. 1 with two analytical lines 14-1 and 14-2 with each having a single micro chromatographic column 30, one skilled in the art will understand that the fast field mud gas analyzer 10 may be provided with any number of analytical lines 14 and each analytical line 14 may be provided with any number of micro chromatographic columns 30.

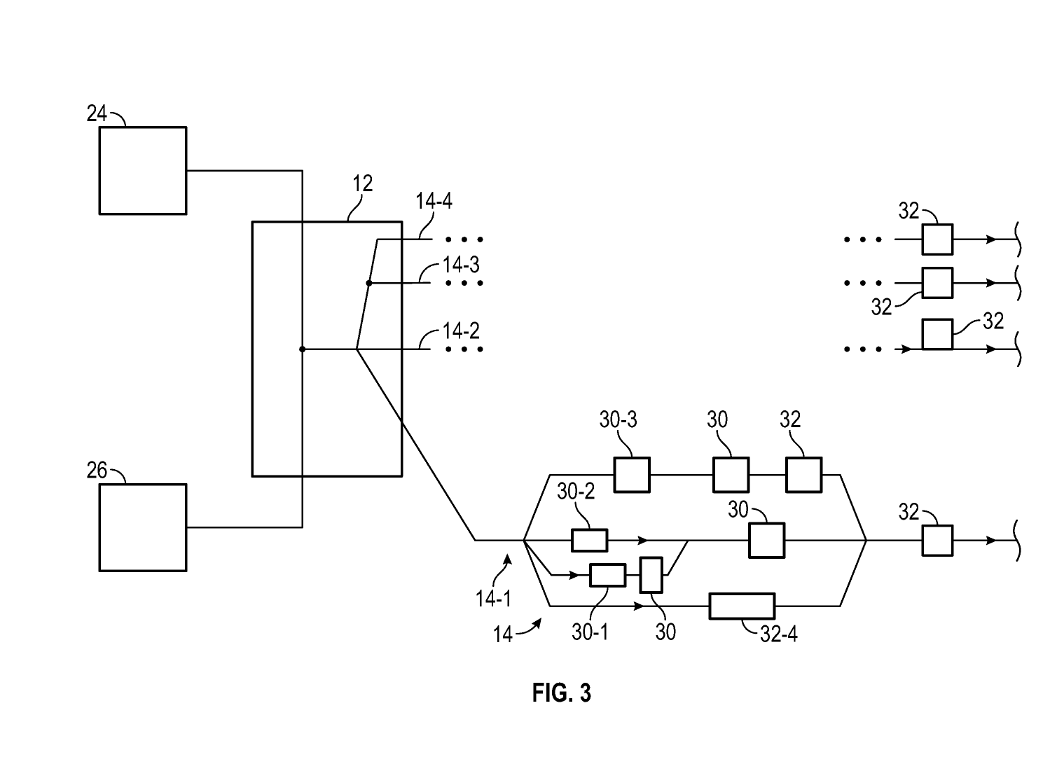

The micro chromatographic columns 30 may be implemented within the analytical line 14 as a single micro chromatographic column 30 or a plurality of micro chromatographic columns 30. For example, as shown in FIG. 3 as will be discussed below, in embodiments including a plurality of micro chromatographic columns 30 for each analytical line 14, the micro chromatographic columns 30 may be provided in parallel and/or in series. By way of example, in an embodiment with the plurality of micro chromatographic columns 30, one micro chromatographic column 30-1 may provide retention times for the separation of C₁-C₃ compounds, a second micro chromatographic column 30-2 may provide retention times for the separation of C₄-C₆ compounds, a third micro chromatographic column 30-3 may provide retention times for C₇-C₁₀ compounds, while other micro chromatographic columns 30 may provide retention times for alcohols, carbon dioxide, hydrogen sulfide, ammonia, or any products of a catalytic reaction between mud gas and the carrier gas for example.

The one or more detector 32 may be, for example, thermal conductivity detectors (TCD), flame ionization detectors (FID), electrochemical sensors, or any other suitable detectors. Multiples of the one or more detectors 32 may be placed in parallel or in series within an effluent sample flow path including one or more analytical lines 14. Provided in parallel, as shown in FIG. 1, the detectors 32 may measure differing qualities of the compounds separated or not from the effluent sample by the micro chromatographic columns 30. Effectively, a part of the effluent sample flow path as shown in FIG. 1, the fast field mud gas analyzer 10 is provided with a first detector 32-1 and a second detector 32-2. In some embodiments, portions of the effluent sample flow may be directed to certain of the analytical lines with specific detectors and portions of the effluent sample flow may be directed through a portion of the analytical line without a micro chromatographic column 30 but various detectors 32 such as an infrared detector, for example as shown in FIG. 3 as detector 32-4.

As shown in FIGS. 1 and 2, the analytical line 14 may be provided with a single detector 32, such that the fast field mud gas analyzer is provided with a first detector 32-1 in fluid communication with the micro chromatographic column 30 of the first analytical line 14-1 and a second detector in fluid communication with the micro chromatographic column 30 of the second analytical line 14-2. The one or more detector 32 may be connected to the computer system 16 via wired or wireless connection such that the one or more detector 32 may communicate information indicative of analysis of the effluent sample flow to the computer system 16. In some embodiments, the computer system 16 may be configured to receive signals, electrical or analogue, from the first and second detectors 32-1 and 32-2, interpret the signals, configure the signals for transmission to another computer system in order to generate the mud gas log automatically. In some embodiments, the fast field mud gas analyzer 10 may be provided with one or more electronic card to treat the signals generated independently by the detectors 32, convert the signals from each detector 32 into a value using calibration curves for the analytical line 14 in fluid communication with the detector 32, reconstruct by time the global chromatographic analysis, and transmit the final result to a computer system, such as the computer system 16. In these embodiments, the fast field mud gas analyzer 10 may be receive and analyze the effluent sample flow with minimal maintenance and with little or no user interaction. The fast field mud gas analyzer 10 may be placed directly at a degasser position or any other suitable location.

The detector 32, in fluid communication with at least one micro chromatographic column 30, may be separated from the micro chromatographic column 30 with the fluid communication formed via tubes, as previously described, such as silicon capillaries, channels, or any other suitable means. For analytical lines 14 where a plurality of micro chromatographic columns 30 are present, the micro chromatographic columns 30 may be connected together with the same type of materials. In other embodiments, each of the plurality of analytical lines 14 may be provided with one or more detectors 32 or may be connected to the same detector 32. In either embodiment, the effluent sample may be separated by the micro chromatographic column 30 and passed to the one or more detector 32 for analysis of the separated compounds within the effluent sample. In yet another embodiment, the detectors 32 may be provided along with the plurality of analytical lines 14 and the splitter system 12 on a substrate.

The one or more heating element 18 may be connected to a micro chromatographic column 30. For example, where a micro chromatographic column 30 is formed between two silicon substrates, the one or more heating element 18 may be connected to one of the silicon substrates to heat at least a portion of the effluent sample flow in the micro chromatographic column 30, and thereby in the analytical line 14. A temperature sensor may also be included to assist the computer system 16 in controlling the heating process using the one or more heating element 18. The analytical lines may be placed in a dedicated furnace to assist in the heating process by limiting heat loss and the size of the device. The heating element 18 and the temperature sensor may be controlled by the computer system 16. In some embodiments the fast field mud gas analyzer 10 may be provided the plurality of analytical lines 14 associated with heating elements 18 and/or furnaces. For example, the fast field mud gas analyzer 10 may be provided with a furnace containing the plurality of analytical lines 14 and each of the plurality of analytical lines 14 may be provided with at least one heating element 18, with each of the plurality of analytical lines 14 having a plurality of heating elements 18 without an encompassing furnace, or with each of the plurality of analytical lines 14 having a plurality of heating elements 18 and encompassed by a plurality of furnaces.

The heating element 18 may be bonded or connected to the micro chromatographic column 30 by adhesive, mechanical connection, or any other suitable means. The heating element 18 may be in the form of a 10Ω heating resistor applied to a portion of the micro chromatographic column 30, such as a silicon wafer into which a portion of the micro chromatographic column 30 has been etched, for example. The heating element may also be in the form of a resistive filament formed from platinum, molybdenum, or any other suitable heating element. The heating element 18 may be configured to provide ramp heating or sustained temperatures to enable appropriate retention time and separation of at least a portion of the effluent sample traveling through the micro chromatographic column 30. The heating element 18 may, for example, provide ramp heating over a predetermined period of time from approximately 20° C. to approximately 160° C., hold the approximately 160° C. temperature for a predetermined period of time, and then cease providing heat for a predetermined period of time. In one embodiment, the ramp heating may occur at a rate of 10° C. per second, for example.

The heating element 18 may be controlled by the computer system 16 to provide programmed or automated ramp heating, temperature holding, and cooling cycles, or may be controlled manually via the computer system 16. The heating element 18 may be connected to a power supply and to the computer system 16 such that the heating element 18 may be controlled through the computer system 16. The temperature sensors may also be connected to a power supply and the computer system 16. The temperature sensors may be configured to provide temperature readings for specific sections of the micro chromatographic column 30 or work in cooperation to provide a temperature reading for the entire micro chromatographic column 30.

In addition to the heating element 18, a cooling system 34 may be provided associated with certain of the plurality of analytical lines 14. The cooling system 34 may be configured to cool at least a portion of the effluent sample flow in the one or more micro chromatographic columns 30 in the analytical line 14 with which the one or more cooling system 34 is associated. The cooling system 34 may be installed prior to an analytical line 14, cooling the effluent sample flow and, in some cases, condenses elements or compounds within the effluent sample flow. The condensates may then be analyzed by the one or more detector 32 in a specific analytical line 14, or a micro chromatographic column 30 within the specific analytical line 14, dedicated to liquid.

Referring now to FIG. 3, therein shown is another embodiment of the fast field mud gas analyzer with the plurality of analytical lines 14. The plurality of analytical lines 14 are shown as a first analytical line 14-1, a second analytical line 14-2, a third analytical line 14-3, and a fourth analytical line 14-4. The second, third, and fourth analytical line 14-2, 14-3, and 14-4 are abbreviated because, in order to perform the mud gas analysis sequentially, each of the plurality of analytical lines 14-1 may be implemented in the same manner. In this way, uniformity between the analytical lines may better enable predictable results and analysis time between the plurality of analytical lines 14. As shown, the first analytical line 14-1 is provided with a plurality of micro chromatographic columns 30 and a plurality of detectors. In this embodiment, some of the detectors 32 are placed in parallel to one another receiving parallel effluent sample flows from parallel micro chromatographic columns 30, and some of the detectors 32 are provided in series with other detectors 32 to perform differing analysis on the same effluent sample flow separated in one or more of the micro chromatographic columns 30. Although a few embodiments are shown, it will be understood by one skilled in the art that any number and/or combination of analytical lines 14, in series or in parallel, having any number and/or combination of micro chromatographic columns 30, in series or in parallel, and detectors 32, in series or in parallel, may be used without departing from the concepts described in the present disclosure.

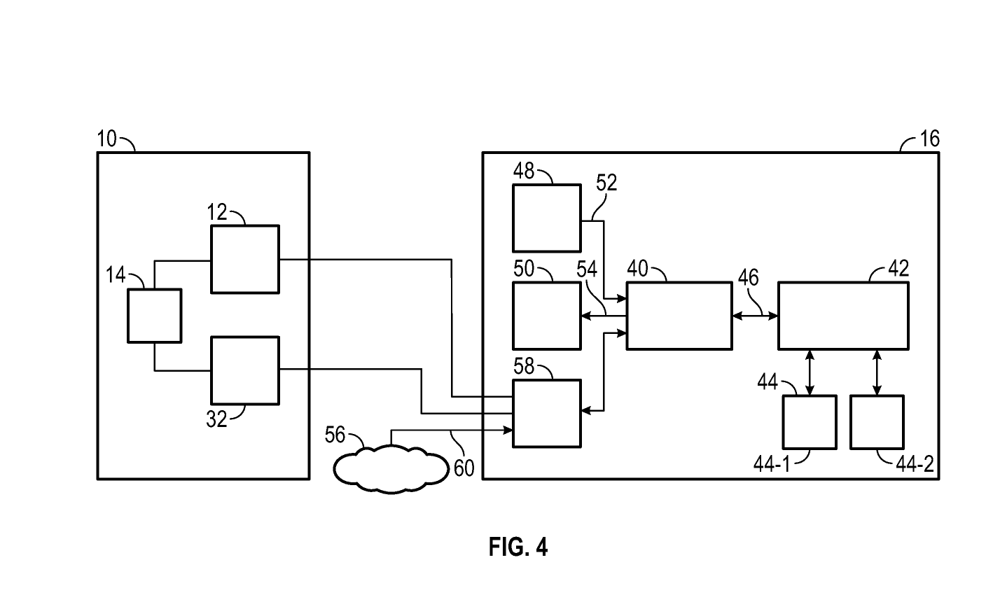

Referring now to FIG. 4, therein shown is one embodiment of the computer system 16 connected to the fast field mud gas analyzer 10 for controlling the operation of the fast field mud gas analyzer 10 to analyze the effluent sample. The computer system 16 may comprise a processor 40, a non-transitory computer readable medium 42, and processor executable instructions 44 stored on the non-transitory computer readable medium 42.

The processor 40 may be implemented as a single processor or multiple processors working together or independently to execute the processor executable instructions 44 described herein. Embodiments of the processor 40 may include a digital signal processor (DSP), a central processing unit (CPU), a microprocessor, a multi-core processor, an application specific integrated circuit, and combinations thereof. The processor 40 is coupled to the non-transitory computer readable medium 42. The non-transitory computer readable medium 42 can be implemented as RAM, ROM, flash memory or the like, and may take the form of a magnetic device, optical device or the like. The non-transitory computer readable medium 42 can be a single non-transitory computer readable medium, or multiple non-transitory computer readable medium functioning logically together or independently.

The processor 40 is coupled to and configured to communicate with the non-transitory computer readable medium 42 via a path 46 which can be implemented as a data bus, for example. The processor 40 may be capable of communicating with an input device 48 and an output device 50 via paths 52 and 54, respectively. Paths 52 and 54 may be implemented similarly to, or differently from path 46. For example, paths 52 and 54 may have a same or different number of wires and may or may not include a multidrop topology, a daisy chain topology, or one or more switched hubs. The paths 46, 52 and 54 can be a serial topology, a parallel topology, a proprietary topology, or combination thereof. The processor 40 is further capable of interfacing and/or communicating with one or more network 56, via a communications device 58 and a communications link 60 such as by exchanging electronic, digital and/or optical signals via the communications device 58 using a network protocol such as TCP/IP. The communications device 58 may be a wireless modem, digital subscriber line modem, cable modem, Network Bridge, Ethernet switch, direct wired connection or any other suitable communications device capable of communicating between the processor 40 and the network 56 and the detectors.

It is to be understood that in certain embodiments using more than one processor 40, the processors 40 may be located remotely from one another, located in the same location, or comprising a unitary multicore processor (not shown). The processor 40 is capable of reading and/or executing the processor executable instructions 44 and/or creating, manipulating, altering, and storing computer data structures into the non-transitory computer readable medium 42.

The non-transitory computer readable medium 42 stores processor executable instructions 44 and may be implemented as random access memory (RAM), a hard drive, a hard drive array, a solid state drive, a flash drive, a memory card, a CD-ROM, a DVD-ROM, a BLU-RAY, a floppy disk, an optical drive, and combinations thereof. When more than one non-transitory computer readable medium 42 is used, one of the non-transitory computer readable mediums 42 may be located in the same physical location as the processor 40, and another one of the non-transitory computer readable mediums 42 may be located in a location remote from the processor 40. The physical location of the non-transitory computer readable mediums 42 may be varied and the non-transitory computer readable medium 42 may be implemented as a “cloud memory,” i.e. non-transitory computer readable medium 42 which is partially or completely based on or accessed using the network 56. In one embodiment, the non-transitory computer readable medium 42 stores a database accessible by the computer system 16 and/or the fast field mud gas analyzer 10.

The input device 48 transmits data to the processor 40, and can be implemented as a keyboard, a mouse, a touch-screen, a camera, a cellular phone, a tablet, a smart phone, a PDA, a microphone, a network adapter, a camera, a scanner, and combinations thereof. The input device 48 may be located in the same location as the processor 40, or may be remotely located and/or partially or completely network-based. The input device 48 communicates with the processor 40 via path 52.

The output device 50 transmits information from the processor 40 to a user, such that the information can be perceived by the user. For example, the output device 50 may be implemented as a server, a computer monitor, a cell phone, a tablet, a speaker, a website, a PDA, a fax, a printer, a projector, a laptop monitor, and combinations thereof. The output device 50 communicates with the processor 40 via the path 54.

The network 56 may permit bi-directional communication of information and/or data between the processor 40 and the network 56. The network 56 may interface with the processor 40 in a variety of ways, such as by optical and/or electronic interfaces, and may use a plurality of network topographies and protocols, such as Ethernet, TCP/IP, circuit switched paths, file transfer protocol, packet switched wide area networks, and combinations thereof. For example, the one or more network 56 may be implemented as the Internet, a LAN, a wide area network (WAN), a metropolitan network, a wireless network, a cellular network, a GSM-network, a CDMA network, a 3G network, a 4G network, a satellite network, a radio network, an optical network, a cable network, a public switched telephone network, an Ethernet network, and combinations thereof. The network 56 may use a variety of network protocols to permit bi-directional interface and communication of data and/or information between the processor 40 and the network 56.

In one embodiment, the processor 40, the non-transitory computer readable medium 42, the input device 48, the output device 50, and the communications device 58 may be implemented together as a smartphone, a PDA, a tablet device, such as an iPad, a netbook, a laptop computer, a desktop computer, or any other computing device.

The non-transitory computer readable medium 42 may store the processor executable instructions 44, which may comprise an operations and analysis program 44-1. The non-transitory computer readable medium 42 may also store other processor executable instructions 44-2 such as an operating system and application programs such as a word processor or spreadsheet program, for example. The processor executable instructions for the operations and analysis program 44-1 and the other processor executable instructions 44-2 may be written in any suitable programming language, such as C++, C#, or Java, for example.

The operations and analysis program 44-1 may have processor executable instructions which enable control of the fast field mud gas analyzer 10 and receiving information from the detectors 32. To control the fast field mud gas analyzer 10, the operations and analysis program 44-1, may allow for manual control of the one or more inlet 20 and the plurality of valves of the splitter system 12, for example. The operations and analysis program 44-1 may also independently operate the one or more heating elements 18 on the plurality of analytical lines 14 to control the temperature of the effluent sample 24 within the micro chromatographic column 30. The operations and analysis program 44-1 may also control the flow rate of the effluent sample 24 and the carrier gas from the carrier gas supply 26. In addition to manual control, the operations and analysis program 44-1 may also enable automated or preprogrammed effluent sample 24 and carrier gas flow rates, activation of the plurality of valves, activation of the one or more inlet 20, and/or operation of the one or more heating element and the one or more cooling element. The operations and analysis program 44-1 may also have processor executable instructions enabling the receiving, interpretation, and output of electrical signals from the detectors indicative of analysis of the effluent sample. The operations and analysis program 44-1, in interpreting and outputting information received from the detectors may create user perceivable outputs, in the form of reports, waveforms, or display screens for example, to provide a user with the information received from the detectors 32.

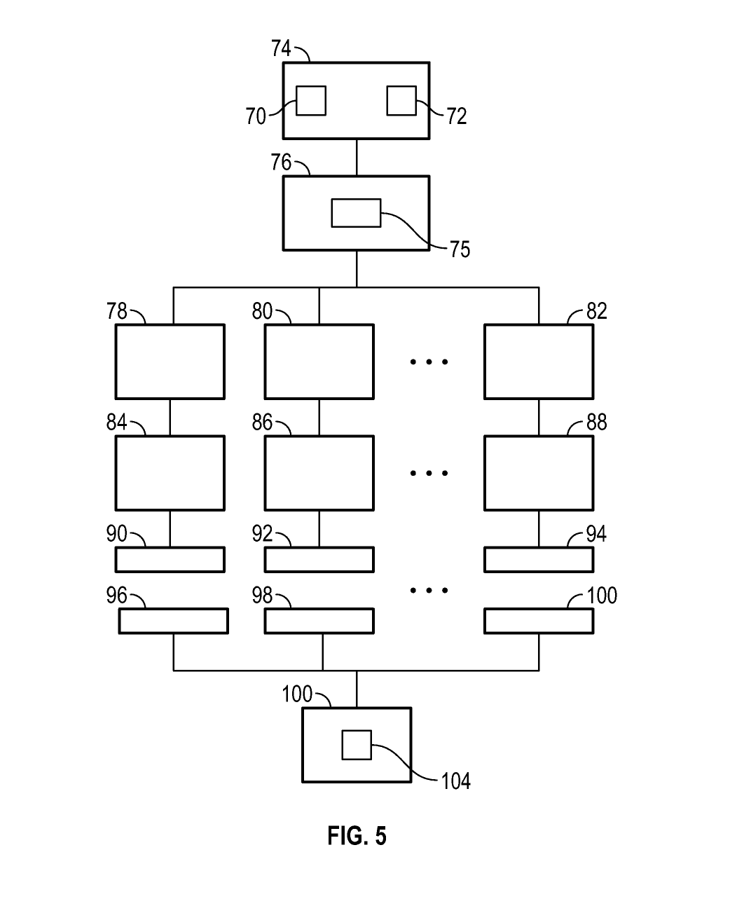

Referring now to FIG. 5, shown therein is a diagrammatic representation of using the fast field mud gas analyzer 10 to conduct rapid readings of the effluent sample flow. Although the fast field mud gas analyzer 10 may be used to analyze qualitative and/or quantitative compositional and isotopic characteristics of fluids and gasses involved in mud gas analysis, for the sake of simplicity, the following description will recite the method in relation to a gaseous effluent. An effluent 70 and a carrier gas 72 may be passed through the fast field mud gas analyzer 10 in block 74. The effluent 70 may be fluid or gas separated from mud gas used while drilling a well bore. The effluent 70 may be indicative of contents of a formation through which the well bore is drilled. In one embodiment, the effluent 70 may be combined with the carrier gas 72 from the carrier gas supply 26 prior to entering the splitter system 12. The effluent 70 and the carrier gas 72 may also be combined after entering the splitter system 12.

Upon entering the splitter system 12 at block 74, an effluent sample flow 75, the combination of the effluent 70 and the carrier gas 72, may be selectively directed to a plurality of analytical lines 14 through the plurality of outlets 22. At block 76, a portion of the operations and analysis program 44-1 may be executed on the computer system 16 to activate the splitter system 12 to apply the effluent sample flow 75 to one of the plurality of outlets 22 to introduce the effluent sample flow 75 to selected analytical lines in a predetermined patter such as a round-robin sequence. At block 78, the computer system 16 may activate the splitter system 12 to apply a first sample 75-1 of the effluent sample flow 75 to the first analytical line 14-1 of the plurality of analytical lines 14 at a discrete instant of time T₁. A portion of the operations and analysis program 44-1 may then activate the splitter system 12 to apply a second sample 75-2 to the second outlet 22-2 and into the second analytical line 14-2 at a discrete instant of time T₂, as shown by block 80. The activation of the splitter system 12 to introduce the second sample 75-2 may be performed after a predetermined delay, such as five, ten, or fifteen seconds, for example. In some embodiments, the operations and analysis program 44-1 may continue introducing portions of the effluent sample flow 75 to the plurality of analytical lines 14 until reaching a last analytical line 14-n at block 82 at a discrete instant of time Tₙ. The final analytical line 14-n may be indicative of any number of a plurality of analytical lines.

After the splitter system 12 has introduced the effluent sample flow 75 to the last analytical line 14-n, and in some embodiments after a predetermined delay, this process may be repeated using any suitable predetermined pattern such as a round-robin sequence to selectively introduce additional portions of the effluent sample flow, such as additional samples 75-x, to the plurality of analytical lines 14. In one embodiment, the splitter system 12 may be activated to flush the plurality of analytical lines 14 with the carrier gas or another inert gas not combined with the effluent, such that the first analytical line 14-1 has been purged of any remaining effluent and carrier gas, prior to reintroduction of a subsequent sample of the effluent sample flow 75 for further analysis by the one or more detector 32 in fluid communication with the analytical line 14 being flushed.

The splitter system 12 may continue to sequentially introduce samples of the effluent sample flow 75 to the first, second, and until the last analytical lines 14-1, 14-2, and 14-n, repeating the pattern and re-introducing samples of the effluent sample flow 75 until a predetermined set of conditions have elapsed, such as a predetermined depth, a predetermined time period, a cessation of drilling, a cessation of operation of the fast field mud gas analyzer 10 by a user, or any other suitable condition.

When the portions of the sample of the effluent sample flow are introduced to the first analytical line 14-1, at the time T₁; the second analytical line 14-2, at time T₂; and continuing until the last analytical line 14-n, at time Tₙ, the first, second, and continuing to the last samples 75-1, 75-2, and 75-n pass through the one or more micro chromatographic column 30 of the first, second, and last analytical lines 14-1, 141-2, and 14-n, at blocks 84, 86, and 88, respectively. At blocks 84, 86, and 88, the first, second, and continuing to the last samples 75-1, 75-2, and 75-n, respectively, contact a stationary phase of the micro chromatographic columns 30 of the analytical lines 14-1, 14-2, and 14-n. As the first, second, and continuing to the last samples 75-1, 75-2, and 75-n pass through the micro chromatographic columns 30, in contact with the stationary phase, the first, second, and continuing to the last samples 75-1, 75-2, and 75-n separate out different elements and compounds depending on the type of stationary phase applied to each of the micro chromatographic columns 30. While the first, second, and continuing to the last samples 75-1, 75-2, and 75-n are separating by the micro chromatographic columns 30, the operations and analysis program 44-1 may activate the one or more heating element 18 associated with the micro chromatographic columns 30 to heat at least a portion of the first, second, and continuing to the last samples 75-1, 75-2, and 75-n within their respective micro chromatographic columns 30, as indicated by blocks 90, 92, and 94, respectively. In some embodiments, also as indicated by blocks 90, 92, and 94, the operations and analysis program 44-1 may also activate the one or more cooling system to cool at least a portion of the first, second, and continuing to the last samples 75-1, 75-2, and 75-n as the first, second, and last samples 75-1, 75-2, and 75-n are being separated by the plurality of micro chromatographic columns 30. As such, elements and compounds within the first, second, and continuing to the last samples 75-1, 75-2, and 75-n, thus separated, may exit the one or more micro chromatographic columns 30 integrated into an analytical line 14 (or micro chromatographic system including many micro chromatographic columns) and contact the one or more detector 32 associated with each of the first, second, and continuing to the last analytical lines 14-1, 14-2, and 14-n, at blocks 96, 98, and 100, respectively.

In one embodiment, where the first, second, and last samples 75-1, 75-2, and 75-n are introduced to the first analytical line 14-1 at the time T₁, the second analytical line 14-2 at the time T₂, and the last analytical line 14-n at the time Tₙ, the separated components of the first sample 75-1 may reach the first detector 32-1 connected to the first analytical line 14-1 at a discrete instant of time T₃, the separated components of the second sample 75-2 may reach the second detector 32-2 connected to the second analytical line 14-2 at a discrete instant of time T₄, and the separated components of the last sample 75-n may reach a last detector 32-n connected to the last analytical line 14-n at a discrete instant of time T₅. The time T₃ is subsequent to the time T₁, the time T₄ is subsequent to the time T₂, and the time T₅, is subsequent to the time Tₙ.

The elements and compounds within the first, second, and last samples 75-1, 75-2, and 75-n, in contact with the detectors 32, at the times T₃, T₄, and T₅, may be analyzed for characteristics such as composition, amount per volume of a sample, changes in thermal conductivity, presence of hydrocarbons, and other characteristics. The elements and compounds within the first, second, and last samples 75-1, 75-2, and 75-n may be analyzed by a plurality of the one or more detectors 32 while exiting the first, second and continuing until the last analytical lines 14-1, 14-2, and 14-n. For example, a TCD may be placed in the flow path of the first, second, and last samples 75-1, 75-2, and 75-n prior to a FID. The TCD may perform non-destructive analysis on the elements and compounds within the first, second, and last samples 75-1, 75-2, and 75-n with the FID performing a destructive test after the elements and compounds are analyzed by the TCD.

At block 102, the one or more detectors 32 may generate information indicative of the analysis of the first, second, and last samples 75-1, 75-2, and 75-n of the effluent sample flow 75 and transmit electrical signals, indicative of the information 104, to the computer system 16. The information 104 may be indicative of characteristics of the separated components within the first, second, and last samples 75-1, 75-2, and 75-n. The components of the first, second, and last samples 75-1, 75-2, and 75-n are analyzed after a period of travel and separation through the one or more micro chromatographic columns 30. In some embodiments, after the first sample 75-1 is introduced to the first analytical line 14-1 and the separated first sample 75-1 exits the first analytical line 14-1, the separated second sample 75-2 may exit the second analytical line 14-2 at a time approximately equal to the predetermined delay described above. In this manner, if the predetermined delay is five, ten, or fifteen seconds, the detectors 32 may analyze and transmit electrical signals indicative of the characteristics of the separated first, second, and last samples 75-1, 75-2, and 75-n at five, ten, or fifteen seconds, respectively. The operations and analysis program 44-1 may receive the electrical signals from the one or more detectors 32 via the one or more wired or wireless connections and process the signals to provide a user perceivable output to a user indicative of the characteristics of the separated effluent samples provided by the detectors 32. The user perceivable output may comprise gas logs for a drilled formation, into which the wellbore is being drilled, with a resolution of gas events at five, ten, or fifteen second intervals, for example. The gas logs of the user perceivable output may have qualitative and/or quantitative compositional and isotopic analysis of the mud gas.

Although the preceding description has been described herein with reference to particular means, materials and embodiments, it is not intended to be limited to the particulars disclosed herein; rather, it extends to functionally equivalent structures, methods and uses, such as are within the scope of the appended claims.

What is claimed is:

1. A fast field mud gas analyzer, comprising:
a splitter system configured to selectively apply a portion of an effluent sample flow through one or more outlets;
a plurality of analytical lines in fluid communication with the splitter system and configured to receive at least a portion of the effluent sample flow from the splitter system, each of the plurality of analytical lines having a micro chromatographic column configured to separate portions of the effluent sample flow and one or more detector configured to analyze the separated portions of the effluent sample flow and generate information indicative of analysis of the portions of the effluent sample flow;
one or more heating element associated with certain of the plurality of analytical lines, the heating elements configured to heat the portion of the effluent sample flow in the analytical line with which the one or more heating element is associated; and
a computer system configured to control the splitter system and the one or more heating element and configured to receive information from the plurality of analytical lines.

2. The fast field mud gas analyzer of claim 1, wherein certain of the plurality of analytical lines, in fluid communication with the splitter system, are connected to the splitter system in parallel.

3. The fast field mud gas analyzer of claim 1, wherein the one or more detector is in fluid communication with the micro chromatographic column via a capillary extending between the micro chromatographic column and the one or more detector.

4. The fast field mud gas analyzer of claim 3, wherein the one or more detector is a first detector, in fluid communication with the micro chromatographic column via a first capillary extending between the micro chromatographic column and the first detector, and a second detector, in fluid communication with the micro chromatographic column via a second capillary extending between first detector and the second detector.

5. The fast field mud gas analyzer of claim 1, wherein certain of the one or more detector is a flame ionization detector.

6. The fast field mud gas analyzer of claim 1, wherein certain of the one or more detector is a thermal conductivity detector.

7. The fast field mud gas analyzer of claim 1, wherein the plurality of analytical lines comprises a first analytical line and a second analytical line and the computer system has processor executable instructions that when executed cause a processor to:
activate the splitter system to apply a first sample of the effluent sample flow to a first outlet of the splitter system and into the first analytical line at a time T₁;
activate the splitter system to apply a second sample of the effluent sample flow to a second outlet of the splitter system and into the second analytical line at a time T₂;
analyze the first sample separated in the first analytical line using a first detector at a time T₃; and
analyze the second sample separated in the second analytical line using a second detector at a time T₄, the times T₃ and T₄ being after the times T₁ and T₂.

8. The fast field mud gas analyzer of claim 7, wherein the processor executable instructions further cause the processor to:
activate the one or more heating element to heat the first sample as the first sample is separated in the first analytical line; and
activate the one or more heating element to heat the second sample as the second sample is separated in the second analytical line.

9. The fast field mud gas analyzer of claim 1 further comprising one or more cooling system associated with certain of the plurality of analytical lines, the one or more cooling system configured to cool the portion of the effluent sample flow directed to the analytical line with which the one or more cooling system is associated.

10. The fast field mud gas analyzer of claim 9, wherein the plurality of analytical lines comprises a first analytical line and a second analytical line and the computer system has processor executable instructions that when executed cause a processor to:
activate the splitter system to apply a first sample of the effluent sample flow to a first outlet of the splitter system and into the first analytical line at a time T₁;
activate the splitter system to apply a second sample of the effluent sample flow to a second outlet of the splitter system and into the second analytical line at a time T₂;
activate the one or more cooling system to cool the first sample as the first sample is separated in the first analytical line;
activate the one or more heating element to heat the first sample as the first sample is separated in the first analytical line;
analyze the first sample separated in the first analytical line using a first detector at a time T₃;
activate the one or more cooling system to cool the second sample as the second sample is separated in the second analytical line;
activate the one or more heating element to heat the second sample as the second sample is separated in the second analytical line; and
analyze the second sample separated in the second analytical line using a second detector at a time T₄, the times T₃ and T₄ being after the times T₁ and T₂.

11. A fast field mud gas analyzer, comprising:
a splitter system configured to selectively apply portions of an effluent sample flow through a plurality of outlets;
a plurality of analytical lines in fluid communication with certain of the plurality of outlets of the splitter system and configured to receive at least a portion of the effluent sample flow from the splitter system, each of the plurality of analytical lines having a plurality of micro chromatographic columns configured to separate portions of the effluent sample flow and one or more first detector configured to analyze the separated portion of the effluent sample flow and generate information indicative of analysis of the portions of the effluent sample flow;
one or more heating element associated with certain of the plurality of analytical lines, the one or more heating elements configured to heat at least a portion of the effluent sample flow in the analytical line with which the one or more heating element is associated; and
a computer system configured to control the splitter system and the one or more heating element and configured to receive the information from the one or more detector.

12. The fast field mud gas analyzer of claim 11, wherein the plurality of analytical lines is connected to the splitter system in parallel.

13. The fast field mud gas analyzer of claim 11, wherein certain of the plurality of micro chromatographic columns of the plurality of analytical lines are in fluid communication with the splitter system and connected to the splitter system in parallel.

14. The fast field mud gas analyzer of claim 11, wherein certain of the plurality of micro chromatographic columns of the plurality of analytical lines are in fluid communication with the splitter system and connected to the splitter system in series.

15. The fast field mud gas analyzer of claim 11, wherein the one or more detector of the plurality of analytical lines is a plurality of detectors and certain of the plurality of detectors are in fluid communication with certain of the plurality of micro chromatographic columns.

16. The fast field mud gas analyzer of claim 11, wherein certain of the one or more detectors are flame ionization detectors.

17. The fast field mud gas analyzer of claim 11, wherein certain of the one or more detectors are thermal conductivity detectors.

18. The fast field mud gas analyzer of claim 11, wherein the plurality of analytical lines comprises a first analytical line and a second analytical line and the computer system has processor executable instructions that when executed cause a processor to:
activate the splitter system to apply a first sample of the effluent sample flow to a first outlet and into the first analytical line at a time T₁;
activate the splitter system to apply a second sample of the effluent sample flow to a second outlet and into the second analytical line at a time T₂;
analyze the first sample separated by the plurality of micro chromatographic columns in the first analytical line using a first detector at a time T₃; and
analyze the second sample separated by the plurality of micro chromatographic columns in the second analytical line using a second detector at a time T₄, the times T₃ and T₄ being after the times T₁ and T₂.

19. The fast field mud gas analyzer of claim 18, wherein the one or more heating element is a first heating element and a second heating element and the processor executable instructions further cause the processor to:
activate the first heating element to heat at least a portion of the first sample of the effluent sample flow as the first portion is separated by the plurality of micro chromatographic columns in the first analytical line; and
activate the second heating element to heat at least a portion of the second sample of the effluent sample flow as the second sample is separated by the plurality of micro chromatographic columns in the second analytical line.

20. The fast field mud gas analyzer of claim 11 further comprising one or more cooling system associated with certain of the plurality of analytical lines, the one or more cooling system configured to cool at least a portion of the effluent sample flow directed to the analytical line with which the one or more cooling system is associated.

21. The fast field mud gas analyzer of claim 20, wherein the plurality of analytical lines comprises a first analytical line and a second analytical line and the computer system has processor executable instructions that when executed cause a processor to:
activate the splitter system to apply a first sample of the effluent sample flow to a first outlet and into the first analytical line at a time T T₁;
activate the splitter system to apply a second sample of the effluent sample flow to a second outlet and into the second analytical line at a time T₂;
activate the one or more cooling system to cool at least a portion of the first sample prior to the first sample entering the plurality of micro chromatographic columns in the first analytical line;
activate the one or more heating element to heat at least a portion of the first sample as the first sample is separated by the plurality of micro chromatographic columns in the first analytical line;
analyze the first sample separated by the plurality of micro chromatographic columns in the first analytical line using a first detector at a time T₃;
activate the one or more cooling system to cool at least a portion of the second sample prior to the second sample entering the plurality of micro chromatographic columns in the second analytical line;
activate the one or more heating element to heat at least a portion of the second sample as the second sample is separated by the plurality of micro chromatographic columns in the second analytical line; and
analyze the second sample separated by the plurality of micro chromatographic columns in the second analytical line using a second detector at a time T₄, the times T₃ and T₄ being after the times T₁ and T₂.

22. A method for analyzing mud gas, comprising:
introducing a first portion of an effluent sample to a first analytical line having one or more micro chromatograph column at discrete instant of time T₁;
introducing a second portion of the effluent sample to a second analytical line having one or more micro chromatograph column at a discrete instant of time T₂;
analyzing the first portion of the effluent sample with one or more detector in fluid communication with the first analytical line at time T₃; and
analyzing the second portion of the effluent sample with one or more detector in fluid communication with the second analytical line at time T₄, the times T₃ and T₄ being subsequent to the times T₁ and T₂.
synchronizing readings of the first and second analytical lines in order to provide an analysis of the effluent sample at a frequency having a period of time in between readings less than a difference in time between the times T₁ and T₃.

23. The method of claim 22 further comprising introducing additional portions of the effluent sample to the first and second analytical lines in a round-robin sequence.
